(19) United States
(12) Patent Application Publication
(10) Pub. No.: US 2001/0027707 A1
(43) Pub. Date: Oct. 11, 2001

(54) Method of successively manufacturing slender square conductive wires

(76) Inventor: Yoshihide Goto, Yamagata (JP)

Correspondence Address: Michael S. Gzybowski, BAKER & DANIELS, 111 East Wayne Street, Suite 800, Fort Wayne, IN, 46802, US

(21) Appl. No.: 09/789,414

(22) Filed: Feb. 22, 2001

(30) Foreign Application Priority Data
Apr. 7, 2000 (JP) 2000-106168

(51) Int. Cl. B26D 3/00

(52) U.S. Cl. 83/44; 83/42

(57) ABSTRACT

A method of manufacturing a square conductive wire which has a square-shape with four equal sides in section, comprises the steps of: preparing a conductive material sheet having a thickness T equal to the length of each the sides of the square-shape and a front and a rear surface 3, 4 which are in parallel to each other; and cutting the conductive material sheet at intervals each being equal to the length of the each the sides by a prescribed length in a direction orthogonal to the front and the rear surface. In this manner, small-sized square conductive wires can be manufactured successively.

### BACKGROUND OF THE INVENTION

1. Field of the Invention

This Invention relates to a method of successively manufacturing slender square conductive wires having a square cross section.

2. Description of the Related Art

For example, in a coil, force F [N] which is generated in a magnetic field with a magnetic flux density B (tesla (T)) is calculated from an equation F=B·I·L where I: a coil current (A), L: effective length (m) of the coil). Therefore, the force to be generated in the magnetic field can be increased by increasing the coil current I (A) and/or the effective length L (m) of the coil. However, in order to implement these means within a limited space such as that of a coil bobbin, the coil must be caused to have an increased sectional area and must be wound as dense as possible.

On the basis of such a theory, a large-sized rectangular or square conductive wire has been used as a coil for a synchrotron, magnetic field generating device for superconducting or a large-scale transformer. The large-sized rectangular or square conductive wire is molded by a known roll diffusion or die cutting.

Incidentally, the molded rectangular or square conductive wire thus manufactured has an “R” at its corners generated by the above technique. This is not problematic because the conductive wire is large-sized or thick.

Meanwhile, in recent years, in order to miniaturize a disk drive or speaker of a portable computer or a DVD (Digital Versatile Disk) or a motor of a vide camera, commercializing of a square conductive wire which is much smaller or thinner than the above square conductive wire has been eagerly demanded.

However, the square conductive wire having a relatively small size manufactured by the above technique involves the “R” at the corner which is large relatively to the size of the square conductive wire. Particularly, the square conductive wire having a size having 1×1 mm or less, which involves a large “R”, could not be made in a desired shape.

In order to create a rectangular shape with no “R” or deformation at the corner of the square conductive wire, slice cutting systems have been widely used in a process of manufacturing many industrial products. However, most of the slice cutting systems, which have a large width, could not be applied to the square conductive wire having a desired size.

For the same purpose, a conductive wire/abrasive machining has been proposed. However, this technique cannot be applied from the standpoint of productivity as a technique for a large amount of conductive wires.

### SUMMARY OF THE INVENTION

This invention has been accomplished under the above circumstance.

An object of this invention is to provide a method of successively manufacturing a square conductive wire having a small size.

In order to attain the above object, in accordance with this invention, there is provided a method of manufacturing a square conductive wire which has a square-shape with four equal sides in section, comprising the steps of:

preparing a conductive material sheet having a thickness equal to the length of each the sides of the square-shape and a front and a rear surface which are in parallel to each other; and

cutting the conductive material sheet at intervals each being equal to the length of the each the sides by a prescribed length in a direction orthogonal to the front and the rear surface.

In accordance with this invention, by cutting a thin conductive material sheet, a slender square conductive wire which is a square in section can be obtained. More specifically, by cutting a very thin conductive material sheet at intervals each being equal to the length of the each the sides in a direction orthogonal to the front and the rear surface thereof, a slender square conducive conductive wire which is a square with greatly reduced sides in section can be manufactured. Using the conductive material sheet having a more reduced thickness, a more slender, or more small-sized square conductive wire can be obtained. Further, by lengthening the conductive material sheet, the square conductive wires can be obtained successively.

In short, in accordance with the method of manufacturing a square conductive wire, small-sized square conductive wires can be obtained successively.

The square conductive wire manufactured by this invention has the following advantages as compared with a round conductive wire which is round in section.

1) The square conductive wire has a sectional area which is about 1.27 times as large as that of the round conductive wire. Therefore, it can be simply concluded that a current which 1.27 times as large as that in the round conductive wire can be passed. This gives force larger by 27% with the same length of coil.

2) The square conductive wire having the same section area that of the round conductive wire can be created by the coil length which is equal to about 86% of the round conductive wire.

3) The square conductive wire does not produce swelling of the outer shape of a winding which is inevitable for the round conducive wire, and so can provide the outer shape of the winding with good size accuracy.

4) The square conductive wire is much advantageous than a rectangular conductive wire in their skin effect.

5) The square conductive wire can be wound in multiple layers like the round conductive wire than the rectangular conductive wire.

The above and other objects and features of the invention will be more apparent from the following description taken in conjunction with the accompanying drawings.

### BRIEF DESCRIPTION OF THE DRAWINGS

FIG. 1 is a view showing an embodiment of a method of manufacturing a square conductive wire according to this invention;

FIG. 2 is a flowchart for explaining the method of manufacturing a square conductive wire;

FIG. 3 is a front view of a first example of a cutting means;

FIG. 4 is a perspective view of a second example of the cutting means; and

FIG. 5 is a front view of a third example of the cutting means.

### DESCRIPTION OF THE PREFERRED EMBODIMENTS

Now referring to the drawings, an explanation will be given of an embodiment of this invention.

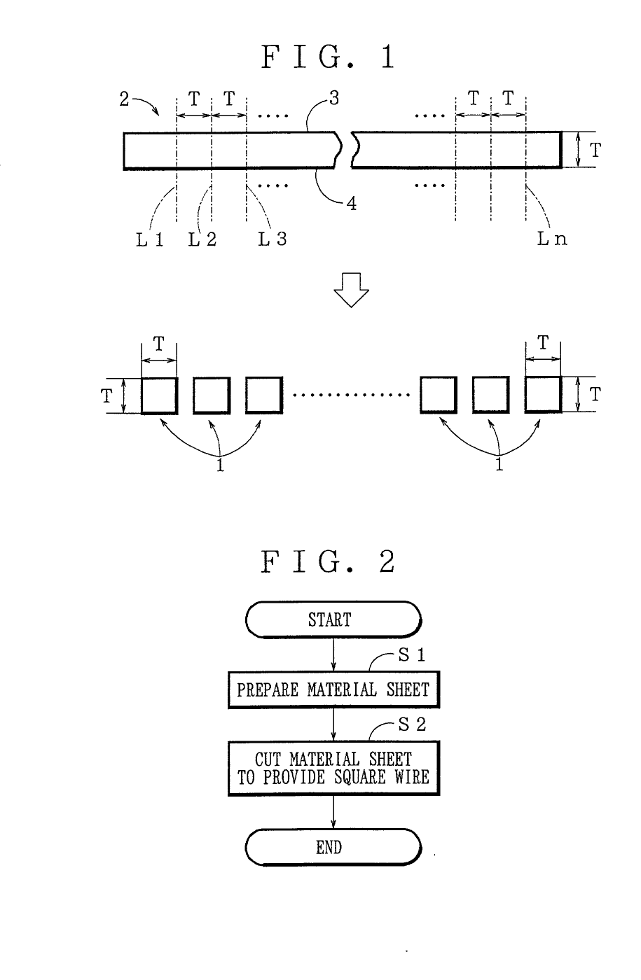

FIG. 1 is a view showing an embodiment of a method of manufacturing a square conductive wire according to this invention; and FIG. 2 is a flowchart for explaining the method of manufacturing a square conductive wire.

As seen from FIG. 1, a square conductive wire 1 with four sides each having a length T in its section is made by cutting a material sheet 2 with a thickness T to provide a width T.

On the basis of the length T of the one side of the square-shape of the conductive wire 1, the thickness T of the material sheet 2 is preferably set within a range of T=1.5 mm˜0.020 mm. The thickness of the material sheet 2 is preferably selected on the basis of the standard of a conductor diameter for “appendix 6: polyurethane” of “JIS C 3202 ENAMEL WIRE”. Thus, the material sheet which is extremely thin is selected. In other words, the square conductive wire 1 is manufactured from the material sheet 2 which is extremely thin.

Referring to FIGS. 1 and 2, a more detailed explanation will be given of the method of manufacturing the square conductive wire 1. The method of manufacturing the square conductive wire 1 having a size of T×T mm comprises the steps of preparing a material sheet 2 (step S1) and cutting the material sheet 2 to obtain the square conductive wire (step S2).

In step S1, the material sheet 2 is prepared as a very thin plate made of a conductive metallic material (e.g. aluminum and copper) having a thickness of T. The material sheet 2 has a front surface 3 and a rear surface which are in parallel to each other. The material sheet 2 has a length required for the square wire 1.

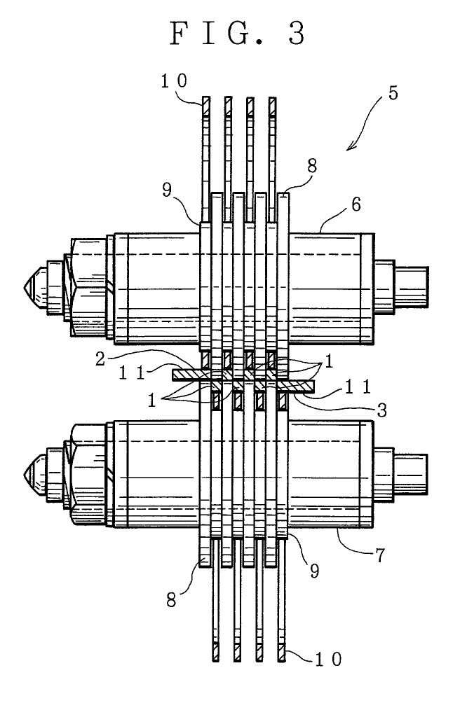

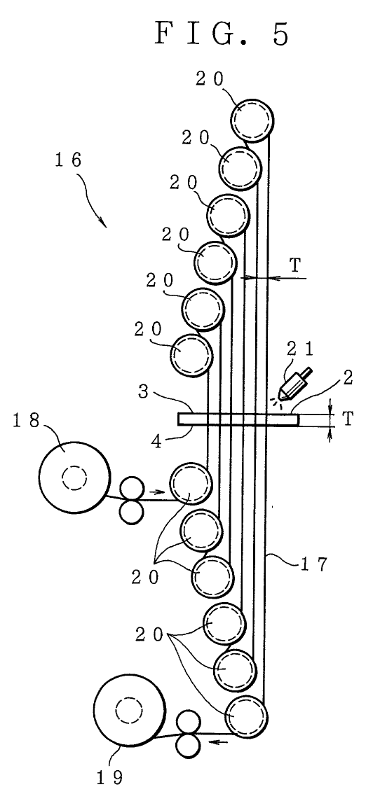

In step S2, the material sheet 2 thus prepared is cut at the respective positions of wires L1 to Ln. The wires L1 to Ln are arranged in parallel at intervals T. The direction of the wires L1 to Ln are orthogonal to the front surface 3 and rear surface 4. The material sheet 2 can be cut by various cutting tools as described below. The cutting tool is built in an apparatus for manufacturing the square conductive wire 1. Referring to FIGS. 3 to 5, three examples of the cutting tool will be explained.

FIG. 3 shows a first example of the cutting tool. In this example, a cutting portion 5 in the above manufacturing apparatus serves as the cutting tool. More specifically, the cutting portion 5 includes an upper axis cutter roller 6 and a lower axis cutter roller 7 which are individually rolled by a servo motor (not shown). The upper axis cutter roller 6 and lower axis cutter roller 7 each has a plurality of disk-shaped cutters at its intermediate portion. The thickness of the cutter is equal to the thickness T of the material sheet 2 (FIG. 1). The cutters of the upper axis cutter roller 6 and those of the lower axis cutter roller 7 are arranged in a staggered configuration.

Between the respective cutters 8 in the upper axis cutter roller 6 and the lower axis cutter roller 7, spacers 9 each having a smaller diameter than that of the cutter 8 are arranged. Rings 10 each is provided to be kept in contact with the outer edge of the spacer 9. The rings 10 each has a sufficiently larger radius of curvature than that of the cutter 8. The axis center of the ring 10 is located outside of that of the cutter 8. The space 9 has a thickness which is slightly larger than the thickness T of the material sheet 2 (FIG. 1). The ring 10 has a thickness which is slightly smaller than the thickness T of the material sheet 2 (FIG. 1).

In operation of the above configuration, while the upper axis cutter roller 6 and the lower axis cutter roller 7 are rolled, the material sheet 2 is fed to between these cutter rollers 6 and 7. Then, the material sheet 2 is cut successively so as to provide a thickness of T by the respective cutters (FIG. 1). In this case, the material sheet 2 will be cut in a direction orthogonal to the front and the rear surface thereof. In accordance with this example, the material sheet 2 thus cut is divided into six square conductive wires and two end members 11 which are a yield.

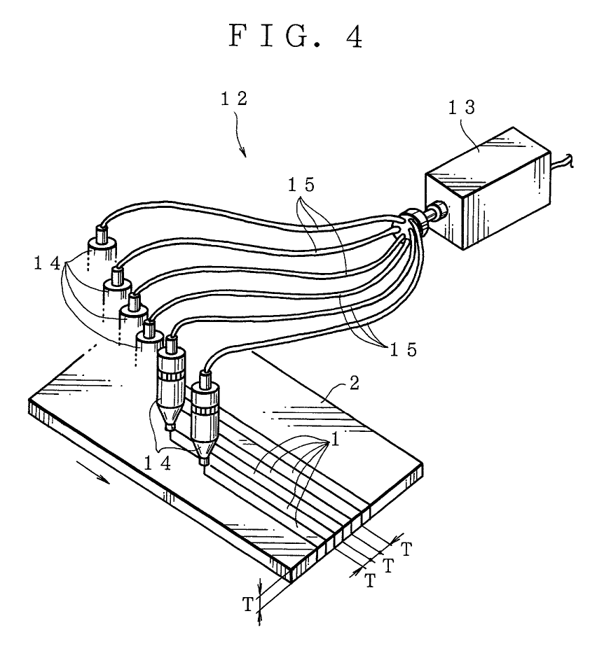

FIG. 4 shows a second example of the cutting tool. In this example, a cutting portion 12 in the above manufacturing apparatus serves as the cutting tool. More specifically, the cutting portion 12 includes a laser oscillator 13. The laser oscillator 13 has a plurality of laser heads 14 arranged by a suitable means. Optical fibers 15 integrally couple the laser oscillator 13 and the laser heads 14 with each other. In operation, the material sheet 2 fed to the cutting portion 12 is cut at intervals of width T by means of the laser oscillator 13. Thus, the square conductive wire 1 (FIG. 1) is obtained.

FIG. 4 shows a third example of the cutting tool. In this example, a cutting portion 16 in the above manufacturing apparatus serves as the cutting tool. More specifically, the cutting portion 16 includes a wire 17. The wire 17 under tension is supplied from a reel 18 and taken up by a reel 19. The wire 17 is stretched at intervals of T in a direction orthogonal to the front surface and the rear surface of the material sheet 2. Incidentally, in FIG. 4, reference numeral 20 denotes a member for direction-inverting for the wire 17. Reference numeral 21 is a nozzle for scattering abrasive and cutting oil. In operation, the material sheet 2 fed to the cutting portion 16 is cut at intervals of width T by the wire. Thus, the square conductive wires 1 (FIG. 1) can be obtained.

As understood from the description with reference to FIGS. 1 to 5, in accordance with this invention, the small-sized or slender square conductive wires can be manufactured successively. The small-sized conductive wire which could not be manufactured by the known roll diffusion bonding and die cutting technique can be manufactured by the manufacturing method according to this invention.

What is claimed is:

1. A method of manufacturing a square conductive wire which has a square-shape with four equal sides in section, comprising the steps of:
preparing a conductive material sheet having a thickness equal to the length of each the sides of the square-shape and a front and a rear surface which are in parallel to each other; and
cutting the conductive material sheet at intervals each being equal to the length of the each the sides by a prescribed length in a direction orthogonal to the front and the rear surface.
